(19) United States
(12) Patent Application Publication
(10) Pub. No.: US 2009/0309072 A1
(43) Pub. Date: Dec. 17, 2009

(54) Bacterial cellulose film and carbon nanotubes-like thin film structures developed from bacterial cellulose

(76) Inventors: Shiaw-Min Hwang, Hsinchu (TW); Han-Ken Chen, Hsinchu (TW); Bing-Joe Hwang, Taipei (TW)

Correspondence Address: ANDREWS KURTH LLP, 1350 I STREET, N.W., SUITE 1100, WASHINGTON, DC, 20005, US

(21) Appl. No.: 12/213,057

(22) Filed: Jun. 13, 2008

(51) Int. Cl. H01M 2/14; D01F 9/12; H01M 4/58; H01B 1/04

(52) U.S. Cl. 252/506; 423/447.2; 423/447.9; 423/447.4

(57) ABSTRACT

A carbon nanotubes-like material is disclosed. The carbon nanotubes-like material comprises bacterial cellulose carbonized under an oxygen-free atmosphere. Also disclosed is a cathode material containing bacterial cellulose and LiFePO_{4,} an anode material containing carbonized bacterial cellulose, a separator membrane containing aldehyde-treated bacterial cellulose, and a lithium battery containing a component comprising bacterial cellulose.

### FIELD OF THE INVENTION

The present invention relates to bacterial cellulose (BC) films and a novel carbon nanotubes (CNT)-like thin film structure developed from BC films. The BC film is preferably produced by Acetobacter spp., most favorably produced by Acetobacter xylinus.

### BACKGROUND OF THE INVENTION

Carbon nanotubes (CNTs) are allotropes of carbon. A single wall CNT is a one-atom thick graphene sheet of graphite (called graphene) rolled up into a seamless deep cylinder with diameter of the order of a nanometer. This results in a nanostructure where the length-to-diameter ratio exceeds 10,000. Such cylindrical carbon molecules have novel properties that make them potentially useful in many applications in nanotechnology, electronics, optics and other fields of materials science. They exhibit extraordinary strength and unique electrical properties, and are efficient conductors of heat.

CNTs are members of the fullerene structural family, which includes buckyballs. Whereas buckyballs are spherical in shape, a nanotube is cylindrical, with at least one end typically capped with a hemisphere of the buckyball structure. Their name is derived from their size, since the diameter of a CNT is on the order of a few nanometers (approximately 50,000 times smaller than the width of a human hair), while they can be up to several millimeters in length. There are two main types of CNTs: single-walled nanotubes (SWNTs) and multi-walled nanotubes (MWNTs).

Most single-walled nanotubes (SWNT) have a diameter of close to 1 nanometer, with a tube length that can be many thousands of times longer. The structure of a SWNT can be conceptualized by wrapping a one-atom-thick layer of graphite called graphene into a seamless cylinder. The way the graphene sheet is wrapped is represented by a pair of indices (n,m) called the chiral vector. The integers n and m denote the number of unit vectors along two directions in the honeycomb crystal lattice of graphene. If m=0, the nanotubes are called “zigzag”. If n=m, the nanotubes are called “armchair”. Otherwise, they are called “chiral”.

Single-walled nanotubes are a very important variety of CNT because they exhibit important electric properties that are not shared by the multi-walled CNT (MWNT) variants. Single-walled nanotubes are the most likely candidate for miniaturizing electronics past the micro electromechanical scale that is currently the basis of modern electronics. The most basic building block of these systems is the electric wire, and SWNTs can be excellent conductors. One useful application of SWNTs is in the development of the first intramolecular field effect transistors (FETs). The production of the first intramolecular logic gate using SWNT FETs has recently become possible as well. To create a logic gate you must have both a p-FET and an n-FET. Because SWNTs are p-FETs when exposed to oxygen and n-FETs when unexposed to oxygen, they were able to protect half of a SWNT from oxygen exposure, while exposing the other half to oxygen. The result was a single SWNT that acted as a NOT logic gate with both p and n-type FETs within the same molecule.

Multi-walled nanotubes (MWNT) consist of multiple layers of graphite rolled in on themselves to form a tube shape. There are two models which can be used to describe the structures of multi-walled nanotubes. In the Russian Doll model, sheets of graphite are arranged in concentric cylinders, e.g., a (0,8) single-walled nanotube (SWNT) within a larger (0,10) single-walled nanotube. In the Parchment model, a single sheet of graphite is rolled in around itself, resembling a scroll of parchment or a rolled up newspaper. The interlayer distance in multi-walled nanotubes is close to the distance between graphene layers in graphite, approximately 3.3 Å. The special place of double-walled CNTs (DWNT) must be emphasized here because they combine very similar morphology and properties as compared to SWNT, while improving significantly their resistance to chemicals. This is especially important when functionalisation is required (this means grafting of chemical functions at the surface of the nanotubes) to add new properties to the CNT. In the case of SWNT, covalent functionalisation will break some C═C double bonds, leaving “holes” in the structure on the nanotube and thus modifying both its mechanical and electrical properties. In the case of DWNT, only the outer wall is modified. DWNT synthesis on the gram-scale was first proposed in 2003 by the CCVD technique, from the selective reduction of oxides solid solutions in methane and hydrogen. See Flahaut et. al (2003), “Gram-Scale CCVD Synthesis of Double-Walled Carbon Nanotubes,” Chemical Communications, 1442-1443, (2003).

Multi-walled CNTs are multiple concentric nanotubes precisely nested within one another, which exhibit a striking telescoping property whereby an inner nanotube core may slide, almost without friction, within its outer nanotube shell thus creating an atomically perfect linear or rotational bearing. This is one of the first true examples of molecular nanotechnology, the precise positioning of atoms to create useful machines. Already this property has been utilized to create the world's smallest rotational motor and a nanorheostat. Future applications such as a gigahertz mechanical oscillator are also envisaged. See A. M. Fennimore et al., “Rotational actuators based on carbon nanotubes,” Nature, 424: 408-410, (2003); John Curnings et.al., “Localization and Nonlinear Resistance in Telescopically Extended Nanotubes,” Physical Review Letters 93, (2004); and John Curnings et.al., “Nanotubes in the Fast Lane,” Physical Review Letters, 88 (2000).

Techniques have been developed to produce nanotubes in sizeable quantities, including arc discharge, laser ablation, high pressure carbon monoxide (HiPco), and chemical vapor deposition (CVD). Most of these processes take place in vacuum or with process gases. CVD growth of CNTs can take place in vacuum or at atmospheric pressure. Large quantities of nanotubes can be synthesized by these methods; advances in catalysis and continuous growth processes are making CNTs more commercially viable.

Although the strength and flexibility of CNTs make them the best candidates for electrical circuits, nanoelectromechanical systems, transparent, electrically conductive films for use in displays for computers, cell phones, PDAs, and ATMs, or even for use in possible drug or gene delivery vehicles, as discussed above, the techniques for developing CNTs in sizable quantities, such as arc discharge, laser ablation, and/or CVD, are difficult to operate and expensive to manufacture. For example, in 2000, single-walled nanotubes were around $1500 per gram, and the development of more affordable synthesis techniques is vital to the future of carbon nanotechnology. Most recently, several suppliers offer as-produced arc discharge SWNTs for ˜$50-100 per gram as of 2007. See, e.g., http://www.carbonsolution.com and http://carbolex.com. Therefore, if cheaper means of synthesis cannot be discovered, it would make it financially impossible to apply this technology to commercial-scale applications.

### SUMMARY OF THE INVENTION

One aspect of the present invention relates to a carbon nanotubes-like material which is made by carbonizing bacterial cellulose (BC) under an anaerobic atmosphere. The BC is produced by a cellulose-synthesizing bacterium, such as Acetobacter, Rhizobium, Agrobacterium, and Sarcina. The preferable cellulose-synthesizing bacterium is Acetobacter xylinus. The carbon nanotubes-like material of the present invention is suitable for use in nanotechnology, electronics, and optics, such as transistors, semiconductors and other electronic components, solar cells, batteries, electronic displays, and optoelectronic devices.

Another aspect of the present invention relates to a method for producing a carbon nanotubes-like material. The method comprises the step of calcining a bacterial cellulose under an anaerobic atmosphere at a temperature range of 600-1200° C.

Another aspect of the present invention relates to a cathode material for lithium batteries. The cathode material contains carbonized bacterial cellulose and LiFePO_{4.}

Another aspect of the present invention relates to an anode material for batteries. The anode material contains bacterial cellulose calcined in a reducing atmosphere containing 2% (v/v) H₂ and 98% (v/v) Ar at 1000° C.

Another aspect of the present invention relates to a separator membrane for a battery. The separator membrane contains bacterial cellulose.

Another aspect of the present invention relates to a lithium battery having a component that contains bacterial cellulose.

Another aspect of the present invention relates to a method for preparing a cathode material. The method comprises the steps of preparing a Li/Fe solution comprising Li⁺ and Fe³⁺; titrating the Li/Fe solution with citric acid; adding PO₄⁻ to titrated Li/Fe solution to form LiFePO₄; adding bacterial cellulose to LiFePO₄ to form a LiFePO₄/bacterial cellulose mixture; and calcining the LiFePO₄/bacterial cellulose mixture to form the cathode material.

Another aspect of the present invention relates to a method for preparing a separator for a battery. The method comprises the steps of treating a bacterial cellulose film with an aldehyde; and baking treated bacterial cellulose film to remove residue aldehyde.

Yet another aspect of the present invention relates to a method for removing hydroxyl groups in a bacterial cellulose film. The method comprises the steps of soaking the bacterial cellulose film in 10% glutaraldehyde at 60° C. for 24 hours; and baking the bacterial cellulose film to remove residue glutaraldehyde.

### DESCRIPTION OF THE DRAWINGS

FIG. 1 is a composite of scanning electron microscopic (SEM) pictures of bacterial cellulose (also known as nata de coco) produced by Gluconacetobacter xylinus subsp. xylinus. (A) SEM picture of nata de coco at 100× magnification; Bar=15.3 μm. (B) SEM picture of nata de coco at 5,000× magnification; Bar=3 μm. (C) SEM picture of nata de coco at 10,000× magnification; Bar=1550 nm. (D) SEM picture of nata de coco at 15,000× magnification; Bar=1080 nm.

FIG. 2 is a composite of four SEM pictures of BC-CNT at different magnification. The BC-CNT was made from nata de coco (as shown in FIG. 1) which had undergone different degree of dehydration before pyrolysis at 1000° C. in the presence of N₂ gas for about 2 hours. (A) SEM picture of BC-CNT produced by 90% dehydrated Nata de coco followed by pyrolysis, at 5,000× magnification; Bar=1 μm. (B) SEM picture of BC-CNT produced by 90% dehydrated Nata de coco followed by pyrolysis, at 50,000× magnification; Bar=100 nm. (C) SEM picture of BC-CNT produced by 99% dehydrated Nata de coco followed by pyrolysis, at 50,000× magnification; Bar=100 nm. (D) SEM picture of BC-CNT produced by 99% dehydrated Nata de coco followed by pyrolysis, at 30,000× magnification; Bar=100 nm.

FIG. 3 is a composite showing the SEM/EDX (Energy Dispersive X-ray) pattern of calcined bacterial cellulose carbon.

FIG. 4 is a composite of diagrams showing the results of the electric conductivity study of the BC-CNTs. The thin film made of BC-CNTs was used as the anode. Metal Li was used as the cathode. EC/DEC LiPF6 (1:1 wt %, 1 M) was used as the elctrolytic solution. The charge/discharge capacity test was conducted under 1 V voltage. (A) The change of specific capacity (Ah) in various cycles; --: Charge; -▪-: Discharge. (B) The change of voltage (V) at various discharge capacity (mAh/g); 2th, 3th, and 20th are numbers of the charge/discharge cycle. (C) The change of voltage (V) at various charged capacity (mAh/g); 1, 2, 3 and 20 are numbers of the charge/discharge cycle.

FIG. 5 is a flow chart showing the synthesis procedure of bacterial cellulose carbon.

FIG. 6 is a diagram showing the synthesis procedure of LiFePO₄/bacterial cellulose carbon.

FIG. 7 is a schematic showing the configuration of a coin battery cell.

FIG. 8 is the Raman spectrum of untreated bacterial cellulose carbon. I_{G} and I_{D} are the intensity of G band (at 1600 cm⁻¹) and D band (at 1360 cm⁻¹) respectively.

FIG. 9 is the Raman spectrum of H₂O₂-treated bacterial cellulose carbon

FIG. 10 is a schematic showing cycle performance of bacterial cellulose carbon cathode material during 0.1 C charging/discharging.

FIG. 11 X-ray diffraction (XRD) patterns of various LiFePO₄/bacterial cellulose carbon ∇=Vaseline; ▾=Fe₂O₃.

FIG. 12 is a composition of SEM pictures showing surface morphology of sample Li_{0.3}C_{1.5}N₀-ac-1-800

FIG. 13 shows the result of elementary analysis of sample Li_{1.03}C_{1.5}N₀-ac-1-800

FIG. 14 is a composite of SEM pictures showing the surface morphology of sample Li₁C_{1.5}N₈—OH-2H

FIG. 15 shows the result of elementary analysis of sample Li₁C_{1.5}N₈—OH-2H.

FIG. 16 is a composite of SEM pictures showing surface morphology of sample Li_{1.03}C_{1.5}N₈-ac-3H-800.

FIG. 17 is a composite showing surface morphology and elementary analysis of sample Li_{1.03}C_{1.5}N₈-ac-3H-800 at various regions

FIG. 18 is a composite of SEM pictures showing surface morphology of sample Li_{1.03}C_{1.5}N₈-ac-3H-900.

FIG. 19 is a composite of SEM pictures showing surface morphology of sample Li_{1.03}C_{1.5}N₈-ac-3H-1000.

FIG. 20 is a composite of Raman spectra of various LiFePO₄/bacterail cellulose carbon.

FIG. 21 is a schematic showing the cyclability of sample Li_{1.03}C_{1.5}N₀-ac-1-800 and sample Li_{1.03}C_{1.5}N₈-ac-3H-800 at 0.1 C charging/discharging rate.

FIG. 22 is a schematic showing the cyclability of the LiFePO₄/10 wt % commercial carbon at various c-rates

FIG. 23 is a schematic showing the cyclability of cathode materials containing LiFePO₄ and 4, 8, 12 wt % bacterial cellulose carbon at a charging/discharging rate of 0.1 C.

FIG. 24 shows first cycle charging/discharging curves of various bacterial cellulose separators at 0.1 C charging/discharging rate.

FIG. 25 is a schematic showing the cyclability of coin battery cells with aldehyde-treated bacterial cellulose separators.

### DETAILED DESCRIPTION OF THE INVENTION

Cellulose is the most abundant biopolymer on earth, recognized as the major component of plant biomass, but also a representative of microbial extracellular polymers, also known as “bacterial cellulose” (“BC”). Although plant cellulose and bacterial cellulose have the same chemical structure, they possess different physical and chemical properties.

Plant cellulose has a fibrous structure, while BC resembles a gel. In its hydrated state, the BC contains over a hundred times its weight in water. Yet both of these substances are built from the same basic unit, which is chains of glucose molecules that are linked by β-1,4-glycosidic bonds. The difference in the properties of these materials results from their nanoscale structural architecture. Cellulose that is synthesized by plants such as cotton (Gossypium spp.) and ramie (Boehmeria nivea) has a structure resembling a heavy-duty rope made of many small fibers twisted into larger fibers that are then twisted into the rope. Thirty-six glucose chains are assembled into an elementary fibril with a diameter of 3.5 nanometers. Microfibrils are assembled into macrofibrils that have a diameter ranging from 30 to 360 nanometers. The macrofibrils are then assembled into fibers. Imaging of cotton linter fibers by atomic force microscopy found an average macrofibril diameter of approximately 100 nanometers. See Hon, “Cellulose: a random walk along its historical path”, Cellulose 1:1 25, (1994); and Franz et al. “Cellulose”, in Methods in Plant Biochem. Vol. 2, Chapter 8, P. M. Dey and J. B. Harborne, editors, Academic Press, London, pages 291 322, (1990).

Although a few bacterial genera (hereinafter “the cellulose-synthesizing bacteria”) are known to be able to produce BC, including Acetobacter, Rhizobium, Agrobacterium, and Sarcina, BC's most efficient producers are Gram-nagative, acetic acid bacteria Acetobacter xylinum, which have been applied as model microorganisms for basic and applied studies on cellulose. One of the most important features of BC is its chemical purity, which distinguishes it from plants, which usually associated with hemicelluloses and lignin, removal of which is inherently difficult.

Acetobacter is a gram-negative, rod shaped bacterium (about 0.6-0.8 μm by 1.0-4 μm). It is strictly aerobic; metabolism is respiratory, never fermentative. It is further distinguished from other microorganisms by its ability to produce multiple poly β-1,4-glucan chains, chemically identical to cellulose. Multiple cellulose chains or microfibrils are synthesized at the bacterial surface at sites external to the cell membrane. These microfibrils have cross sectional dimensions of about 1.6 nm×5.8 nm. In static or standing culture conditions, the microfibrils at the bacterial surface combine to form a fibril having cross sectional dimensions of about 3.2 nm×133 nm.

The production of BC from the cellulose-synthesizing bacteria was known since half of a century ago when S. Hestrin et al. discovered that Acetobacter xylinum (recently renamed as Gluconacetobacter xylinus according to the American Type Culture Collection) could synthesize cellulose in the presence of glucose and oxygen. See S. Hestrin et al., “Synthesis of Cellulose by Resting Cells of Acetobacter xylinum”, Nature 159: 64 65, (1947).

Acetobacter xylinus has been used for the production of the food product nata de coco in the Philippines. Cellulose is secreted by the microorganism in the form of a twisted ribbon 40 to 60 nanometers wide that is extruded at a rate of 2 micrometers/minute. Each ribbon consists of 46 microfibrils, each of which has an average cross-section of 1.6×5.8 nanometers. These twisted ribbons, roughly corresponding to the macrofibrils of plant cellulose, assemble into sheets outside the cell, that combine to form a centimeter-thick layer called a pellicule on the surface of the culture medium. Scanning electron microscopy has revealed that, inside the pellicule, the fibrils are organized to form tunnels with a diameter of 7 micrometers, large enough for the bacteria to move through. See, S. Hestrin et al. (supra); S. Hestrin, et al., “Synthesis of cellulose by Acetobacter xylinum: Preparation of freeze-dried cells capable of polymerizing glucose to cellulose”, Biochem. J., 58: 345 352, (1954); and Cannon et al., “Biogenesis of Bacterial Cellulose”, Crit. Reviews in Microbiol. 17(6): 435 447, (1991).

The aforementioned nata de coco or coconut gel has been produced for domestic consumption in the Philippines for at least 100 years. Nata de coco is the gel-like cellulose pellicule formed on the surface of media by Acetobacter xylinum cultures. In recent years, it has become one of the most popular Filipino food exports.

The unique properties of the BC synthesized by Acetobacter have inspired attempts to use it in a number of commercial products. These include tires (see, e.g., U.S. Pat. No. 5,290,830), headphone membranes (see, e.g., U.S. Pat. No. 4,742,164), paper (see, e.g., U.S. Pat. No. 4,863,565), textiles (see, e.g., U.S. Pat. No. 4,919,753), dietary fiber (see, e.g., U.S. Pat. No. 4,960,763). Medical applications include a specially prepared membrane to be used as a temporary skin substitute for patients with large burns or ulcers (see, e.g., U.S. Pat. No. 4,912,049, and Fontana, et al., “Acetobacter Cellulose Pellicule as a Temporary Skin Substitute”, Appl. Biochem. Biotech. 24/25: 253 264 12, (1990)).

As of today, no one has ever connected the abundance of BC to a source for producing the CNTs (i.e., BC-CNTs), and further utilized the unique characteristics of the BC-CNTs in the areas of nanotechnology, electronics, and optics, such as transistors, semiconductors and other electronic components, solar cells, batteries, electronic displays, and optoelectronic devices, etc.

The idea of utilizing BC as the source of CNTs came from the recognition that cellulose is an unbranched polymer of β-1,4-linked glucopyranose residues having the following chemical formula:

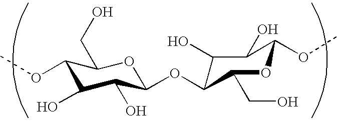

In other words, cellulose is made of carbon, oxygen, and hydrogen elements only, so that if the oxygen and hydrogen elements are removed, cellulose is left with only carbon atoms, a characteristics shared with diamond and graphite. Additionally, the size and structure of BC are in the nano ranges, which are similar to the carbon nanomaterials. BC is about 30-100 nm in diameter and is arranged in a nano-hexagonal network structure, which, again, is somewhat similar to the CNT structure. More importantly, unlike plant cellulose, which contains impurities such as lignin and hemicellulose, BC is relatively pure, so that the manufacturing processes and conditions for making BC are easy to control. Therefore, it has been hypothesized by the inventors of the present invention that if the BC could be treated at high temperature in the absence of oxygen to break up the C—O and C—H bonds within the cellulose, so as to leave only carbon as residue, they could create a structure resembling the CNT.

Accordingly, one aspect of the present invention relates to BC-CNT prepared by a pyrolysis process which includes the step of calcining BC under an anaerotic atmosphere. The BC is synthesized by a cellulose-synthesizing bacterium, including, but not limited to, the genera of Acetobacter, Rhizobium, Agrobacterium, and Sarcina. The preferred cellulose-synthesizing bacterium is Acetobacter xylinus, especially Acetobacter xylinus subsp. xylinus, which produces BC having a diameter of about 30-50 nanometer, which is the smallest among all of the known nature cellulose.

Pyrolysis is the chemical decomposition of organic materials by heating in the absence of oxygen or any other reagents, except possibly steam. In other words, pyrolysis is a special case of thermolysis. Extreme pyrolysis, that leaves only carbon as the residue, is called carbonization. There are generally three kinds of commonly used pyrolysis. The first kind of pyrolysis is anhydrous pyrolysis, which is usually understood to be conducted without water. This phenomenon commonly occurs whenever solid organic material is heated strongly in absence of oxygen, e.g., when frying, roasting, baking, or toasting. Even though such processes are carried out in a normal atmosphere, the outer layers of the material keep its interior oxygen-free.

The second kind of pyrolysis is hydrous pyrolysis. This kind of pyrolysis refers to the thermal decomposition which take place when of organic compounds are heated to high temperatures in the presence of water or steam.

The third kind of pyrolysis is vacuum pyrolysis, in which organic material is heated in a vacuum in order to decrease boiling point and avoid adverse chemical reactions. It is used in organic chemistry as a synthetic tool.

The pyrolytic method used in the present invention for manufacturing BC-CNT, however, was conducted under an oxygen-free atmosphere. In one embodiment, the pyrolysis was conducted under a nitrogen atmosphere (100% N₂). In another embodiment, the pyrolysis was conducted under a reducing atmosphere, such as 2% H₂ and 98% Ar. The pyrolysis is typically conducted at a temperature of 600-1200° C., and preferably at a temperature of 800-1000° C. The heating process of pyrolysis may also be referred to as “calcining,” “sintering,” or carbonizing.”

This BC-CNT thin film could be dissolved in special solvents (such as halogenated organic solvent, CH₂Cl_{2,} organic solvent, toluene, xylene or water). The dissolved BC-CNT could be sprayed to form new thin film with increased or decreased thickness and various transparancy and electrical conductivity.

Another aspect of the present invention relates to a lithium battery that contains a component made from bacterial cellulose. As used herein, the term “lithium battery” refers to any battery that has a lithium-containing anode, a lithium-containing cathode, or a lithium-containing electrolyte.

In one embodiment, the component made from bacterial cellulose is a cathode. Preferably, the cathode contains a mixture of LiFePO₄ and carbonized bacterial cellulose.

LiFePO₄ has many required electrochemical characteristics of a battery material, such as high electric capacity, high structural stability and low cost. However, the electrical conductivity of LiFePO₄ is only in the range of 10⁻⁹ to 10⁻¹⁰ S/cm⁻¹, which severely limited the utility of LiFePO₄ in commercialized and mass-produced batteries. Bacterial cellulose films possess the characteristics of both nano carbon fiber and porous film. They can be used as cathode material in lithium batteries to enhance the electrical conductivity of LiFePO₄ by absorbing LiFePO₄ sol-gel in the pores of bacterial cellulose carbon nano fiber scaffold.

In another embodiment, the component made from bacterial cellulose is an anode. and the bacterial cellulose is carbonized bacterial cellulose. Preferably, the bacterial cellulose is carbonized by calcining in a reduction environment of H₂/Ar. Bacterial cellulose films calcined under high temperature anaerobic condition are good anode material because they maintain the carbon nano-fiber structure formed by polysaccharide and have high electrical conductivity.

In another embodiment, the component made from bacterial cellulose is a separation membrane and the bacterial cellulose is an aldehyde-treated bacterial cellulose. The aldehyde treatment is necessary to remove the hydroxyl groups in the bacterial cellulose. Preferably, the bacterial cellulose is treated with 10% glutarladehyde at 60° C. for two hours.

Another aspect of the present invention relates to a cathode material for lithium batteries. The cathode material contains bacterial cellulose and LiFePO_{4.}

Another aspect of the present invention relates to an anode material for batteries. The anode material contains carbonized bacterial cellulose.

Another aspect of the present invention relates to a separator membrane for a battery. The separator membrane contains aldehyde-treated bacterial cellulose.

Another aspect of the present invention relates to a method for preparing a cathode material. The method contains the steps of preparing a Li/Fe solution comprising Li⁺ and Fe³⁺; titrating the Li/Fe solution with citric acid, adding PO₄⁻ to titrated Li/Fe solution to form LiFePO₄; adding bacterial cellulose to form a LiFePO₄/bacterial cellulose mixture; and calcining said LiFePO₄/bacterial cellulose mixture to form said cathode material.

Another aspect of the present invention relates to a method for preparing carbonized bacterial cellulose. The method contains the step of calcining bacterial cellulose in an anaerobic atmosphere containing 100% N₂ or in a reducing atmosphere containing 2% (v/v) H₂ and 98% (v/v). The carbonized bacterial cellulose can be used as anode material in a battery.

Yet another aspect of the present invention relates to a method for preparing a separator membrane for a battery. The method comprises the steps of treating a bacterial cellulose film with an aldehyde and baking treated bacterial cellulose film to remove residue aldehyde.

The following experimental designs and result are illustrative, but not limiting the scope of the present invention. Reasonable variations, such as those occur to reasonable artisan, can be made herein without departing from the scope of the present invention. Also, in describing the invention, specific terminology is employed for the sake of clarity. However, the invention is not intended to be limited to the specific terminology so selected. It is to be understood that each specific element includes all technical equivalents which operate in a similar manner to accomplish a similar purpose.

### EXAMPLES

### Example 1

### Equipments and Materials

### Equipments

1. X-ray diffraction: Rigaku Dmax-B, Japan

2. Scanning electron microscope: JEOL JSM-6500F FESEM

3. Energy—Dispersive X-ray Analysis: JSM6500

4. Synchrotron radiation source, National Synchrotron Radiation Research Center at Hsinchu, Taiwan, (NSRRC)

5. Field Emission Scanning Electron Microscope (FE-SEM)

6. Raman spectrometry: Dilar XY model, argon ion laser (wavelength 514.5 nm) 20 mW

7. Thermogravimetric Analyzer (TGA): Perkin Elmer TGA-7

8. Eight-channel battery cells tester: Maccor

9. Programmable Speedy High Temperature Furnace: homemade

10. Coin battery cell assembly: Hosen (2032)

11. Glovebox workstation: UNIlab MBRAUN

12. Lithium metal cutter: Xinhe Science and Technology Co., Ltd.

13. Coin battery cells pressing machine: Haoju Company

### Bacterial Cellulose

The Bacterial cellulose (nata de coco) used in this study was produced by Gluconacetobacter xylinus subsp. xylinus, which was provided and maintained by the Bioresources Collection and Research Center, Food Industry R&D Institute, Hsinchu, Taiwan. The nata de coco film was in the size of 20×30×0.5 cm. Before experiments, the nata de coco film was cleaned by water and stored at room temperature in pure water after sterilized in 121° C. for about 30 minutes.

Chemicals

| | | |
|---|---|---|
| 1. | Lithium hydroxide, LiOH•H₂O, 56% | ACROS |
| 2. | Lithium acetate, CH₃COOLi | ACROS |
| 3. | Ferric nitrate, Fe(NO₃)₃, 99% | ACROS |
| 4. | Ammonium phosphate (NH₄H₂PO₄) 99% | ACROS |
| 5. | Citric acid, C₆H₈O₇, 99.5% | ACROS |
| 6. | Formaldehyde, CH₂O, 37%, | ACROS |
| 7. | Glutaraldehyde, C₅H₈O₂, 50%, | Aldrich |
| 8. | Polyvinylidene Fluoride (PVDF) | Aldrich |
| 9. | N-methyl-2-pyrrolidone (NMP) | Aldrich |
| 10. | Lithium hexafluorophosphate, LiPF6, | Aldrich |
| 11. | Ethylene carbonate (EC) | Aldrich |
| 12. | Diethylcarbonate (DEC) | Aldrich |

### Example 2

### Methods

### High Temperature Carbonization of Nata De Coco

The nata de coco samples were undergone dehydration treatment. The dehydrated nata de coco samples were placed in a high temperature oven and undergone pyrolysis for about 2 hours at 1000° C. The high temperature oven was infused with N₂ gas. The pyrolysis treated nata de coco samples (i.e., BC-CNTs) were undergone scanning electron microscopy (SEM), and transmission electron microscopy (TEM) studies, and tested for electrical conductivity, charge/discharge, and lithium battery simulation.

### Sample Preparation for Scanning Electron Microscropy (SEM)

The decolored and acid-removed nata de coco or BC-CNT samples were cut into about 5 mm×5 mm small squares under an analytic microscope, and soaked in 0.1 M phosphate buffer containing 2% OSO₄ fixative at 4° C. overnight. The samples were washed with distilled water twice (each time for about 15 minutes), and underwent dehydration by transferring the samples to 10%, 20%, 30%, 40%, 50%, 60%, 70%, 80%, 90%, 95%, 100%, and 100% ethanol solution, each for about 15 minutes. The samples in the 100% ethanol solution were then stepwisely replaced with ⅓, ⅔, 100%, and 100% acetone, each for about 15 minutes. The samples in 100% acetone were then placed in a critical point dryer (CDP) (Hitachi HCP-2) where the remaining acetone was replaced by liquid CO₂. The dehydrated nata de coco or BC-CNT samples were obtained after the liquid CO₂ in the CDP was gasified upon the increase of temperature in the CDP. The dehydrated samples was coated with a layer of gold particles to be observed under the SEM (Hitachi S-450) at 20 Kv accelerated voltage.

### Sample Preparation for Transmission Electron Microscropy (TEM)

### A. Sample Preparation:

The nata de coco or BC-CNT samples were cut into about 1-2 mm³ small pieces under an analytic microscope, and soaked in a 4% glutaraldehyde fixative in 0.1 M phosphate buffer for about 4 hours. The samples were rinsed with 0.1 M phosphate buffer twice (each time for about 15 minutes). The samples were then soached in 0.1 M phosphate buffer containing 2% OSO₄ fixative at 4° C. overnight. The OSO₄ fixed samples were washed with distilled water twice (each time for about 15 minutes). The samples were then underwent dehydration by transferring the samples to 10%, 20%, 30%, 40%, 50%, 60%, 70%, 80%, 90%, 95%, 100%, and 100% ethanol solution, each for about 15 minutes. The samples in the 100% ethanol solution were then stepwisely replaced with ⅓, ⅔, 100%, and 100% acetone, each for about 15 minutes. The acetone in the samples was then replaced with Agar 100 resin (a replacement of about ⅓ per day, with at least 4-5 times) until finally all of the acetone was replaced with 100% fresh resin. The samples were vacuumed for about 2 hours to remove any remaining acetone, and plate embedded or put in a aluminum foil plate to be put in an oven with a temperature set at 70° C. for about 3 days to allow the resin to solidify to form a block. The resin-embedded samples block was sliced at about 2 μm thickness each time using a fresh glass knife on the rotary microtome, until close to the samples areas, where the rotary microtome was changed to a Reichert-Ultracut to produced super-thin slices of about 65-90 nm in thickness. These thin slices were collected and mounted on a copper net, which was pre-coated with a collodion film and plated with carbon.

### B. Staining of the Slices:

The sample staining was conducted in a petri disch. Prior to the staining procedure, NaOH particles were placed around a petri dish for about 10 minutes to absorb any CO₂ in the petri dish. A few drops of lead citrate (dye) were then added to the paraffin plate of the petri dish. The nata de coco or BC-CNT thin slices were then placed onto the paraffin plate with the samples faced down for about 30 minutes. The excess lead citrate on the sample thin slices was then removed by washing with fresh 0.02 N NaOH solution, followed by washing with distilled water. The excess water was absorbed by filter paper. A filter paper containing 50% alcohol was then placed in the petri dish to maintain the humidity of the staining environment. About 10 μl of saturated uranyl acetate staining solution dissolved in 50% alcohol was added to the paraffin plate. The sample containing copper net was then placed in the staining solution and stained for about 60 minutes. The stained samples were washed with 50% alcohol, followed by washing with distilled water. The excess water was removed by a filter paper. The samples were ready for TEM observation when the copper net was dried.

### C. TEM Observation:

The stained sample slice on the copper net was placed under a TEM (Hitachi H600) and observed under 75 kv accelerated voltage.

### Preparation of Bacterial Cellulose Carbon

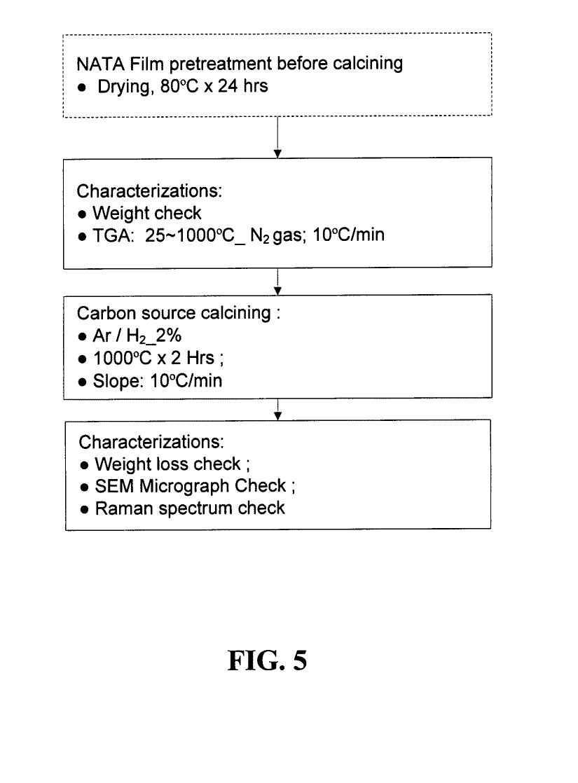

As shown in FIG. 5 carbonized bacterial cellulose was prepared with the following steps:

1. Dry bacterial cellulose film in an oven at 80° C. for 24 hours.

2. Weigh the dried bacterial cellulose film to determine the weight loss after drying and subject the dried bacterial cellulose film to TGA analyses.

3. Calcine the dried bacterial cellulose film under the reducing gas of 2% H₂ (v/v)/98% Ar (v/v) at 1000° C. for 2 hours, with an elevated heating rate of 10° C. per minute.

4. Weigh the calcined bacterial cellulose film to determine the final weight loss and analyze the calcined bacterial cellulose film with scan electron microscopy (SEM), Raman spectrometry, etc.

### Preparation of LiFePO₄/Bacterial Cellulose Carbon Cathode Material

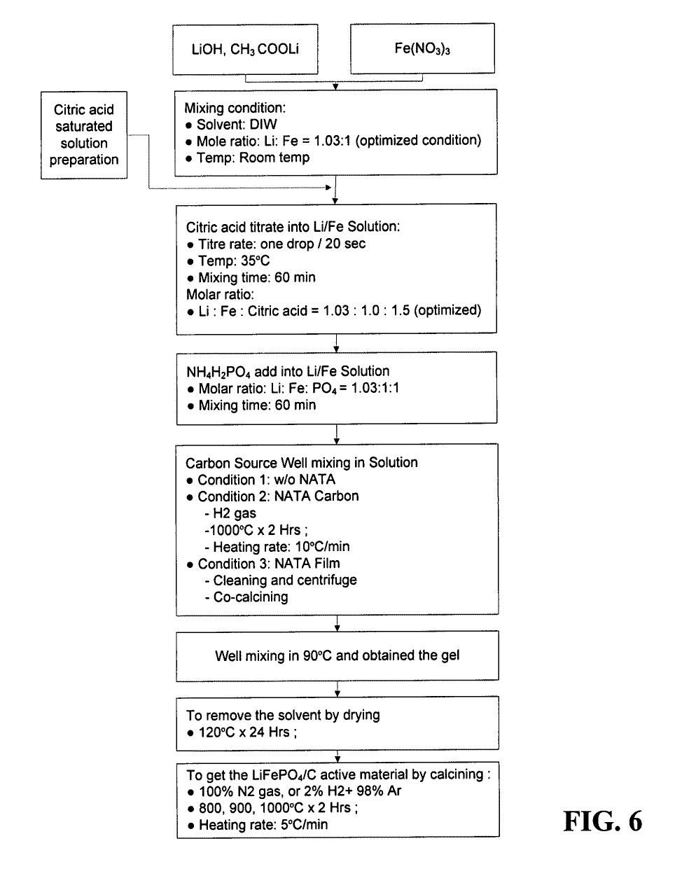

As shown FIG. 6, LiFePO₄/bacterial cellulose carbon cathode material was prepared with the following steps:

1. Dissolve lithium acetate and ferric nitrate in deionized water at a molar ratio of 1.03 to 1.

2. Prepare a saturated water solution of citric acid, and titrate the citric acid slowly (one drop per 20 second) into the mixture of lithium salt and ferric nitrate at 35° C. to a final Li:Fe:Citric acid molar ratio of 1.03:1.0:1.5 and mix for 60 min.

3. Add ammonium phosphate to the titrated solution to a final Li:Fe:PO₄ molar ratio of 1.03:1:1, and mix for 60 min.

4. Add carbon source under the following three conditions:

(1) add no bacterial cellulose carbon, use citric acid as carbon source.

(2) add bacterial cellulose that is calcined under reducing atmosphere at 1000° C.

(3) add uncalcined bacterial cellulose, mix the bacterial cellulose with LiFePO₄ solution thoroughly.

5. Heat the mixtures in step 4 to 90° C. to evaporate the water until the mixtures present a gel-like appearance.

6. Bake the gel-like mixtures in a furnace at 120° C. for 24 hours to remove all the water in the gel-like mixtures (LiFePO₄ precursor).

7. Calcine the completely dried LiFePO₄ precursor in a high temperature furnace under 100% N₂ or 2% H₂ (v/v)/98% Ar (v/v) at a temperature of 800, 900 or 1000° C. for 2 hours. The heating rate is 5° C. per min.

### Preparation of Separator

1. Cut a dried bacterial cellulose film to appropriate size.

2. Soak the dried bacterial cellulose film in 5% formaldehyde, 5% glutaraldehyde, or 10% glutaraldehyde at 60° C. for 24 hours.

3. Dry the aldehyde-treated bacterial cellulose film at 100° C. for 24 hours.

4. Cut the dried aldehyde-treated film to appropriate sized separator membrane and equilibrate the separator membrane in a glovebox workstation.

5. Treat the separator membrane with the normal procedure, soak the membrane in a solution of 1M LiPF₆ in EC:DEC (1:1).

### Nomenclature of Samples

The sample codes are listed in Table 1.

TABLE 1
Sample codes

| | | Molar Ratio | | |
|---|---|---|---|---|
| | | Li:Fe:PO₄:Citric | Calcination | |
| | Lithium | acid:bacterial | Temperature | Calcination |
| Sample No | Source | cellulose carbon(wt %) | (° C.) | Atmosphere |
| Li₁C_{1.5}N₈—OH-2H | LiOH | 1:1:1:1.5:8% | 1000, 800 | N₂, 2% H₂ + 98% Ar |
| Li_{1.03}C_{1.5}N₀-ac-1-800 | CH₃COOLi | 1.03:1:1:1.5:0 | 800 | N₂ |
| Li_{1.03}C_{1.5}N₈-ac-3-800 | CH₃COOLi | 1.03:1:1:1.5:8% | 800 | N₂ |
| Li_{1.03}C_{1.5}N₈-ac-3H-800 | CH₃COOLi | 1.03:1:1:1.5:8% | 800 | 2% H₂ + 98% Ar |
| Li_{1.03}C_{1.5}N₁₂-ac-3H-800 | CH₃COOLi | 1.03:1:1:1.5:12% | 800 | 2% H₂ + 98% Ar |
| Li_{1.03}C_{1.5}N₄-ac-3H-800 | CH₃COOLi | 1.03:1:1:1.5:4% | 800 | 2% H₂ + 98% Ar |
| Li_{1.03}C_{1.5}N₈-ac-3H-900 | CH₃COOLi | 1.03:1:1:1.5:8% | 900 | 2% H₂ + 98% Ar |
| Li_{1.03}C_{1.5}N₈-ac-3H-1000 | CH₃COOLi | 1.03:1:1:1.5:8% | 1000 | 2% H₂ + 98% Ar |

For example, in the code name Li_{1.03}C_{1.5}N₈-ac-3H-900.
Li_{1.03} stands for: Li_{1.03}FePO_{4.}
C_{1.5} stands for Citric acid (5% Carbon) in a Li:Fe:PO₄:Citric acid molar ratio of 1:1:1:1.5.
N₈ stands for 8 wt % of bacterial cellulose carbon.
OH stands for LiOH as the lithium source.
ac stands for CH₃COOLi as the lithium source.
3H stands for carbon source condition 3 with calcination under 2% H₂+98% Ar.
900 stands for calcination temperature of 900° C.

### Electrochemical Property Test

### (a) Preparation of Cathode Sheet

1. Equilibrate the freshly prepared LiFePO₄/bacterial cellulose carbon cathode material in a glovebox workstation for 24 hours.

2. Weigh cathode material and Polyvinylidene Fluoride (PVDF) at a weight ratio of 85 (cathode material):15 (PVDF).

3. Place the cathode material into sample bottle A and PVDF into sample bottle B, and add NMP solvent in an amount just enough to cover the cathode material and PVDF in each bottle, mix and stir for 2 hours.

4. Preheat a stainless sheet to 120° C. in a furnace.

5. Transfer the well-mixed active cathode material powder in sample bottle A into sample bottle B, add two agitate balls, and stir at a constant speed of 300 rpm for 30 min.

6. Cut a piece of aluminum foil a desired size, wash in NaOH solution (10 g NaOH in 250 ml deionized water) for 3 min, wash with deionized water, then store in ethanol.

7. Clean the preheated stainless sheet with ethanol, place the aluminum foil on the stainless steel sheet, and prepare the scraper with a 200 mm blade.

8. Pour the well-mixed slurry of step 5 onto the aluminum foil, spread the slurry on the aluminum foil with the scraper.

9. Bake the coated aluminum foil with the stainless steel sheet into a vacuum oven at 120° C. for about 2 hours to remove the residual solvent.

10. Preheat the press machine to 50° C., press the aluminum foil for 5-6 times at a thickness setting of 100-150 mm.

11. Prepare round cathode sheet and several pieces of uncoated aluminum foil having a diameter of 1.3 cm with a cutter, equilibrate the cathode sheet and aluminum foil in glove box workstation for at lease 12 hours.

12. Weigh the equilibrated cathode sheet and uncoated aluminum foil, calculate the weight of active cathode material (weight of active cathode material=weight of the balanced cathode sheet−weight of uncoated aluminum foil).

13. Assemble a coin battery cell with the equilibrated cathode sheet for conducting the charging/discharging test.

### Assembly of Coin Battery Cell

1. Clean all the components of a coin cell assembly with 95% ethanol, dry in a furnace at 80° C., and balance in a glovebox workstation

2. Place the weighed cathode sheet on the center of the bottom cape of the coin battery cell assembly.

3. Wet the cathode sheet with a drop of electrolyte liquid.

4. Cover the cathode sheet with a separator (diameter=1.8 cm) that is socked in electrolyte liquid, and ensure that the cathode is at the center of the bottom cap.

5. Place an O-ring onto the separator.

6. With a lithium cutter, cut a round piece of lithium metal (diameter=1.6 cm) as anode, place the lithium metal on the separator.

7. Sequentially, put a stainless current collector and a wavy washer onto the lithium metal anode sheet.

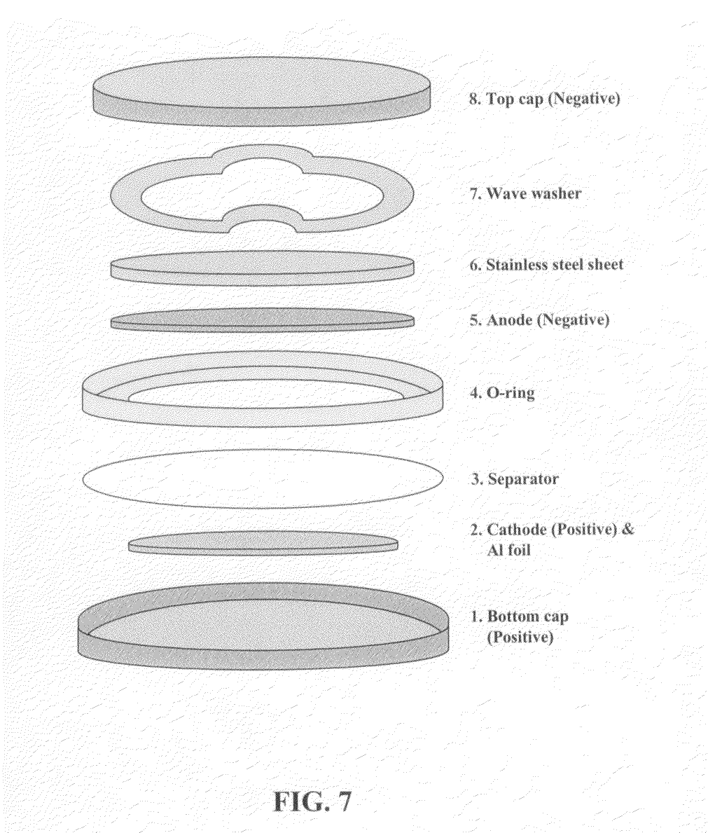

8. Cover with a top cap at the end, press with pressing machine specially designed for coin battery cells, and seal the coin cell assembly. FIG. 7 shows the configuration of a coin battery cell assembly.

### Example 3

### SEM Observation of Nata De Coco and BC-CNT Samples

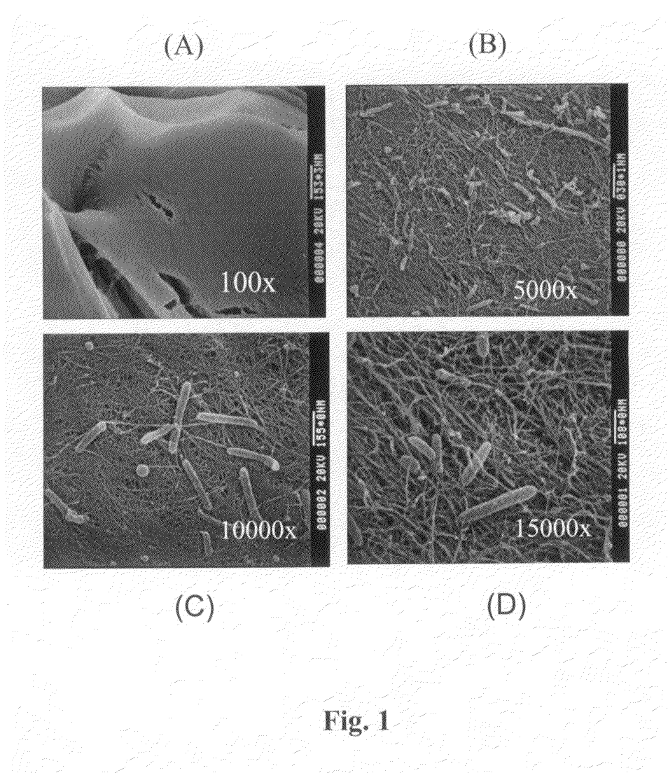

The nata de coco synthesized by Gluconacetobacter xylinus subsp. xylinus was bacterial cellulose (BC), which is a kind of carbohydrate. The primary product of BC was in pale yellow color. After excessive washing, the BC became white color. BC had a smooth texture when it was under visual observation or by touching. However, under SEM, the BC demonstrated the typical fibril-like structure (FIG. 1). When the BC was viewed under higher magnification, the fibrilar structures of the bacterial cellulose and the rod-shaped bacteria could be seen in panels (B), (C), and (D) of FIG. 1.

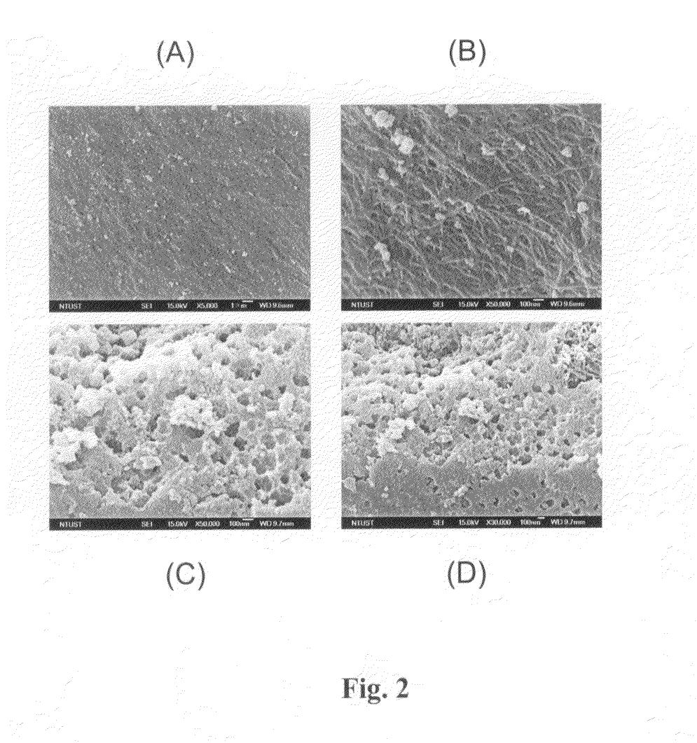

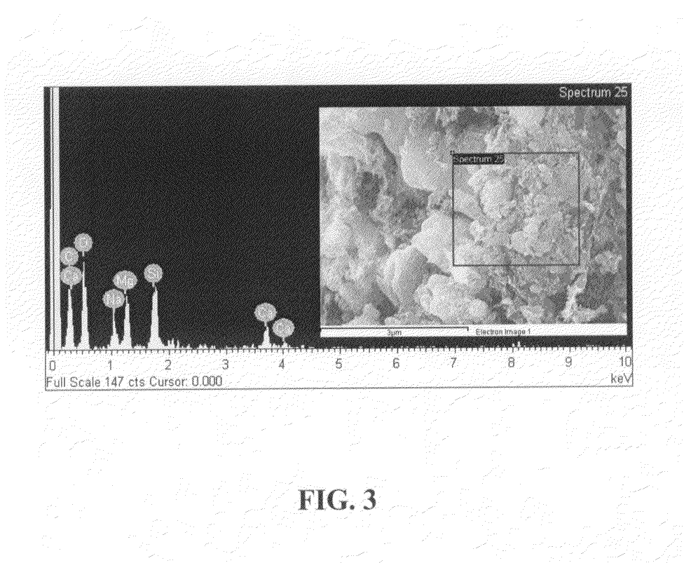

When the nata de coco was undergone pyrolysis at 1000° C. for about 2 hours under N₂ gas, the sample (BC-CNT) turned into a pure black thin film. However, the degree of the retention of the fibrilar-structure in the pyrolytic nata de coco varied depending upon the degree of dehydration of the nata de coco prior to pyrolysis. As shown in panels (A) and (B) of FIG. 2, the BC-CNT still maintained the fibril-like structure when the nata de coco was 90% dehydrated before pyrolysis. Shown on the same pictures (panels (A) and (B) of FIG. 2), some non-crystalline substances could be seen attached to the BC-CNT, which might be the pyrolyzed bacteria. The presence of non-crystalline substances might affect the electrical conductivity of the BC-CNT, which conductivity was not as good as the CNT derived from graphite. FIG. 3 shows the surface morphology and elementary analysis of some of the non-crystalline substances. It can be seen that there are some inorganic impurities on the surface of the calcined bacterial cellulose carbon.

As shown in panels (C) and (D) of FIG. 2, when the nata de coco was dehydrated to about 99% before the pyrolysis was conducted, the fibril-like structure disappeared, and a graphite-like CNT thin film structure was formed, which was further characterized as porous. Due to the relatively inexpensive and simple manufacturing process for making nata de coco and BC-CNT, and the unlimited resource of the materials, the potential of BC-CNT to be used in the nanotechnolgy, electronics, and optics, such as transistors, semiconductors and other electronic components, solar cells, batteries, electronic displays, and optoelectronic devices, etc., are anticipated. As will be discussed in more details later, the porous structure of the BC-CNT was particularly useful for use in lithium battery because it works to facilitate the LiFePO₄ gel infiltration so as to improve the electrical conductivity and thermal tolerance of the lithium battery.

### Example 4

### Electrical Conductivity of BC-CNT

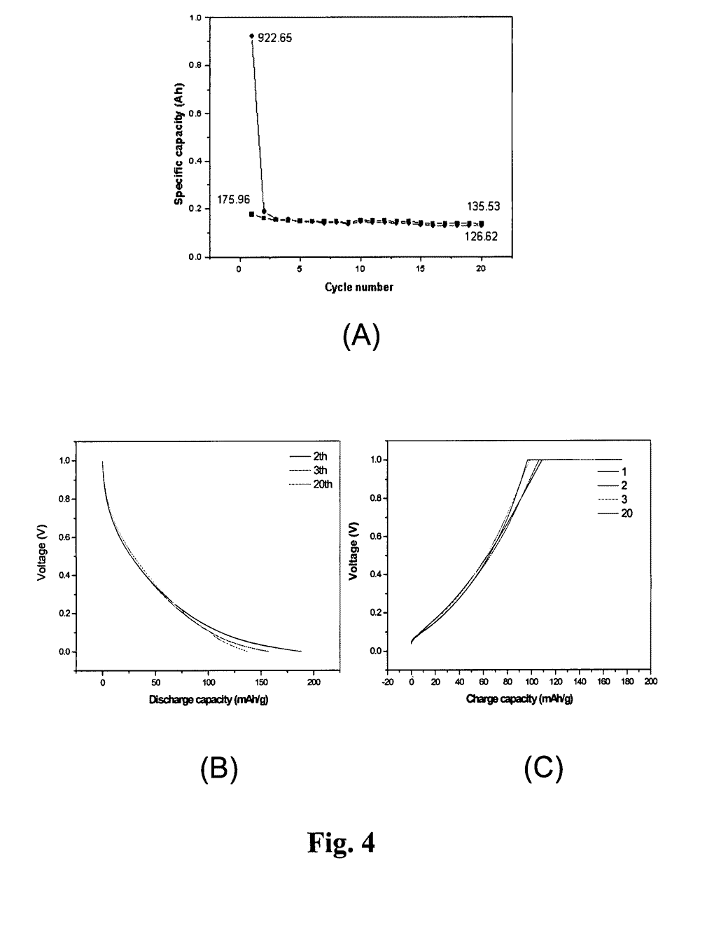

The electrical conductivity of the BC-CNT was studied by placing the BC-CNT thin film at the anode, and metal Li at the cathode in a electrolytic solution containg EC/DEC LiPF6 (1:1 wt %, 1 M). As shown in Panel (A) of FIG. 4, the charge and discharge capacity of BC-CNT reached a balance quickly when 1 V voltage was used. The stable charge capacity was 135.53 Ah/g, and the discharge capacity was 126.62 Ah/g.

### Example 5

### Graphitization Analysis of the Bacterial Cellulose Carbon

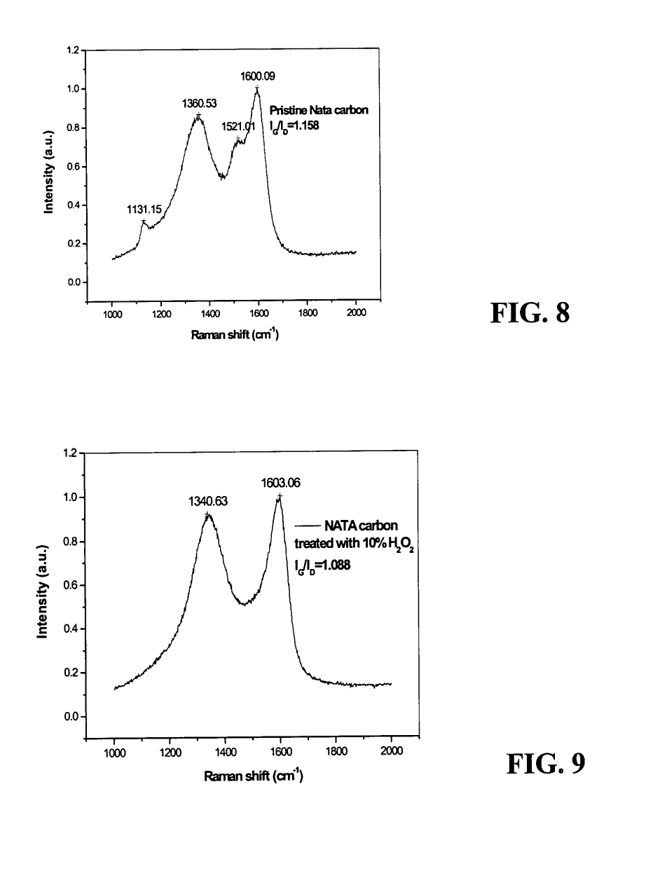

The electrochemical property of carbonized bacterial cellulose carbon was determined by the degree of graphitization. Roman spectrum was used to distinguish and resolve the sp2 bond and determine the percentage of graphite component in the bacterial cellulose carbon. FIG. 8 shows that untreated bacterial cellulose carbon has a G graphite band (sp2 structure, represents graphite component) that is stronger than the D (defect) band (sp3 structure, represent non-graphite component). The G/D ratio is 1.158. Carbon impurities (non-crystalline phase carbon?) were found at 1521.01 cm⁻¹ and 1131.15 cm⁻¹.

In contrast, the non-crystalline phase carbon can be effectively removed by treating the bacterial cellulose film with hydrogen peroxide (H₂O₂) prior to calcination (FIG. 9). However, as shown in FIG. 9, the level of graphitization decreased dramatically. The G/D band ratio was reduced to from 1.158 (untreated) to 1.088 (H₂O₂ treated). This result indicated that while the H₂O₂ treatment may remove impurities, it may also destroy the ring-like structure of cellulose and make it more difficult to graphitize during carbonization process of cellulose.

### Example 4

### Electrochemical Property Test

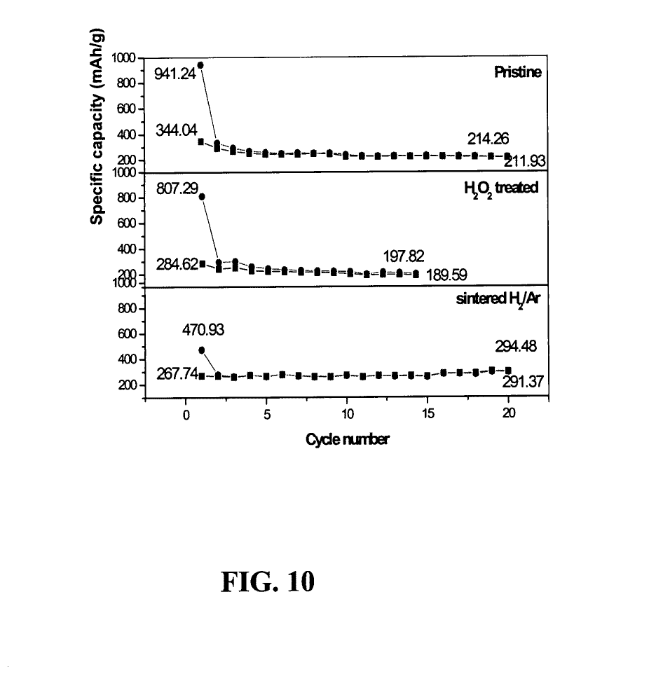

Coin cells were assembled using bacterial cellulose carbon prepared under various carbonization conditions, and were subjected to charging/discharging test at a rate of 0.1 C (i.e., 1/10 of the theoretical electric capacity per hour). As shown in FIG. 10, bacterial cellulose carbon prepared under three different conditions were compared. Under condition (1) bacterial cellulose film was washed with deionized water (Pristine) and calcined under N₂ at 1000° C. Under condition (2), bacterial cellulose film was washed with H₂O₂ and then calcined under N₂ at 1000° C. (H₂O₂-treated). Under condition (3) bacterial cellulose film was only washed with deionized water (Pristine), and then calcined under reducing H₂/Ar atmosphere.

As shown in FIG. 8, the irreversible electric capacity of bacterial cellulose carbon cathode made under either condition (1) or (2) were higher than 500 mAh/g, indicating that the content of carbon impurity was too high. Furthermore, the charging/discharging times declined quickly and the stable electric capacity is low under condition (1) and (2). The electric capacity was reduced to 211.93 mAh/g from the original 344.04 mAh/g after 20 cycles under condition (1), while the electric capacity was decreased to 189.59 mAh/g from the original 284 mAh/g after 15 cycles under condition (2). However, the bacterial cellulose carbon treated with reducing H₂/Ar atmosphere possessed a stable charging/discharging property, and the electric capacity remained at about 290 mAh/g after 20 cycles, and even increased slightly in the later cycles.

Compared with the electric capacity of 320 mAh/g of commercially available graphite carbon, the electric capacity of bacterial cellulose carbon is still low. However, the commercially available graphite carbon is graphitized at a graphitization temperature of up to 3000° C. Bacterial cellulose carbon, on the other hand, can be produced at a much lower temperature (about 1000° C.) and hence a much lower cost. Therefore, carbonized bacterial cellulose has a great potential to replace the commercially available graphite.

### Example 5

### Crystal Structure Analysis of LiFePO₄

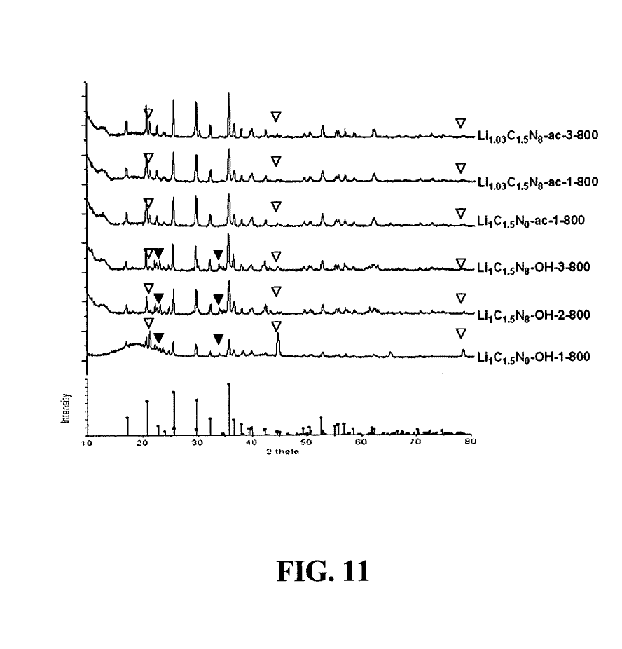

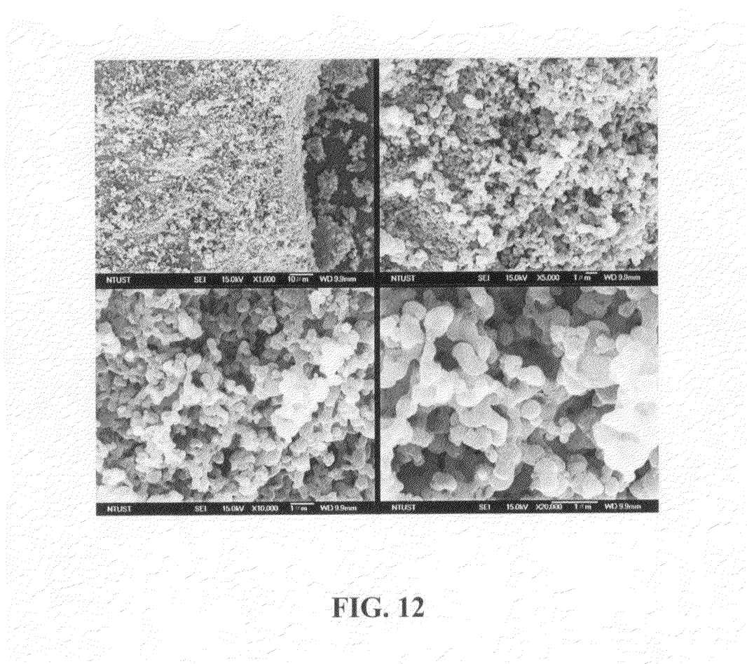

The purity of synthesized LiFePO₄ was analyzed by XRD diffraction spectrum. As shown in FIG. 11, the calcined LiFePO₄ sol-gel products using lithium hydroxide (LiOH) as the lithium source all showed a peak corresponding to standard LiFePO_{4,} but they all had some impurities such as Fe₂O_{3.} In contrast, when lithium acetate (CH₃COOLi) was used as the lithium source, pure LiFePO₄ was obtained. These results demonstrated that the synthetic condition can be better controlled with lithium acetate.

### Example 6

### Surface Morphology and Elementary Analysis of LiFePO₄/Bacterial Cellulose Carbon

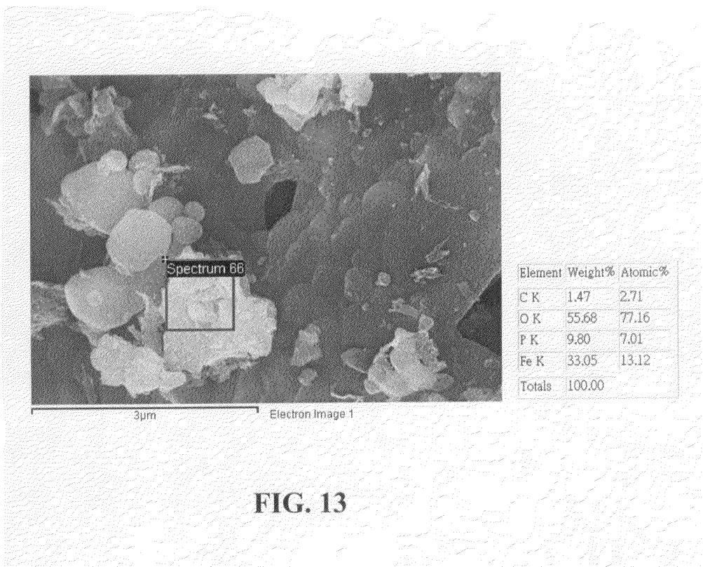

The LiFePO₄/bacterial cellulose carbon products calcined under different conditions were subjected to SEM and EDX analysis. As shown in FIG. 12, the surface of sample Li_{1.03}C_{1.5}N₀-ac-1-800 was fully covered by LiFePO₄ particles with a diameter of about 500-700 nm. EDX analysis revealed, however, that the carbon content was very low due to the lack of bacterial cellulose carbon (FIG. 13). Compared with the atomic % of P atoms, the high atomic % of Fe and O atoms suggested the existence of Fe₂O₃ impurity.

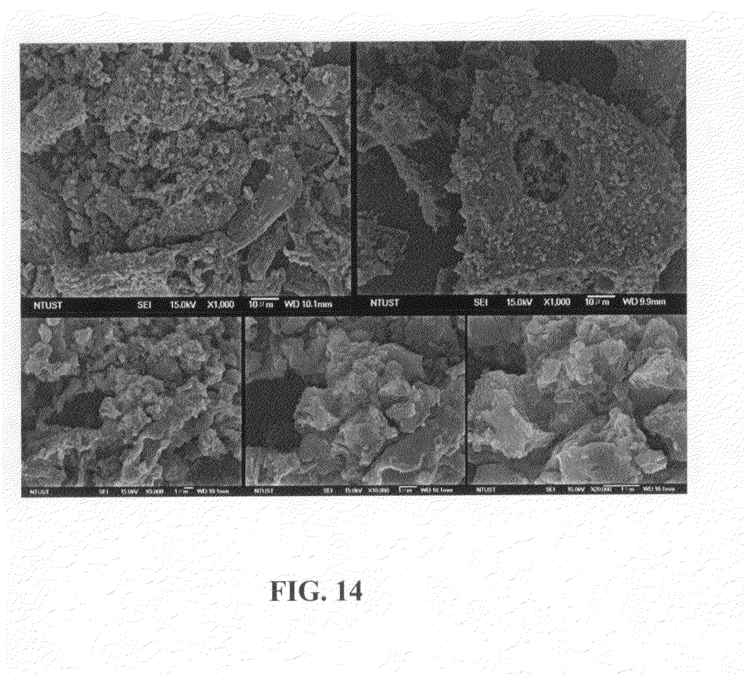

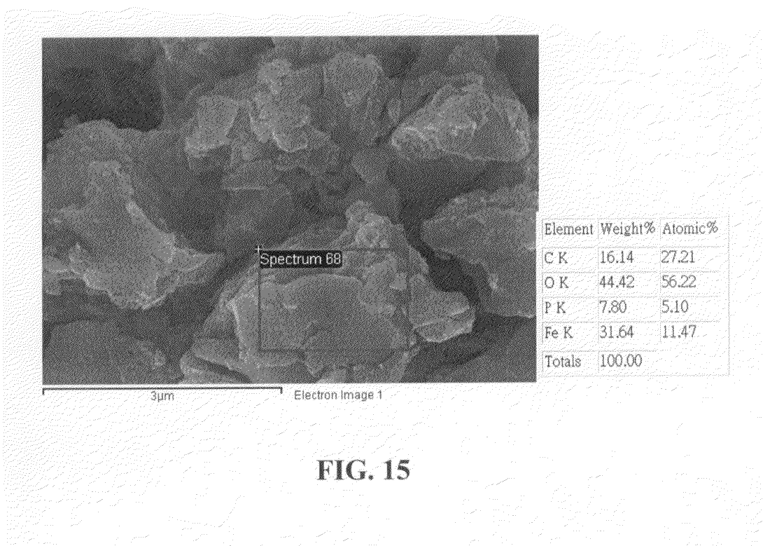

As shown in FIG. 14, LiFePO₄ and bacterial cellulose carbon was mixed well in sample Li₁C_{1.5}N₈—OH-2H. Almost no LiFePO₄ particles existed on the surface of the bacteria cellulose carbon. Fe₂O₃ was still detectable in some small areas. As shown by the EDX images in FIG. 15, the high atomic % of Fe and O atoms suggested the existence of Fe₂O₃. The carbon content of sample Li₁C_{1.5}N₈—OH-2H was much higher than that of sample Li_{1.03}C_{1.5}N₀-ac-1-800, largely due to the addition of bacterial cellulose carbon.

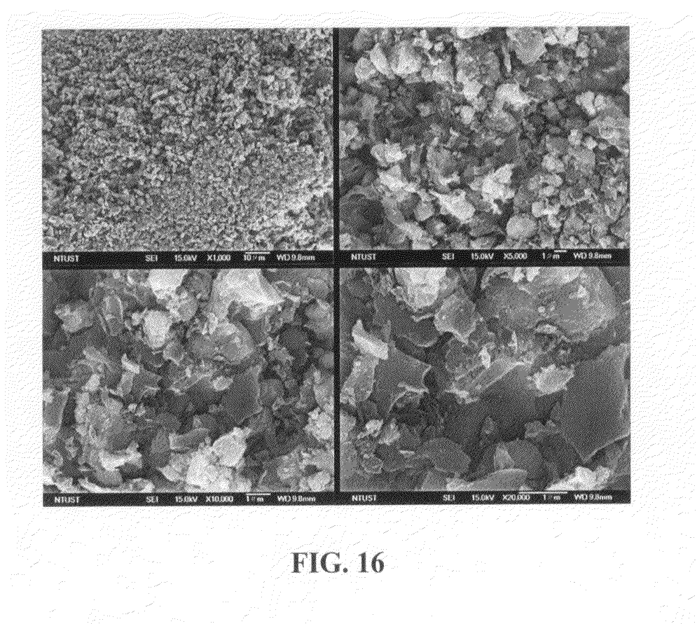

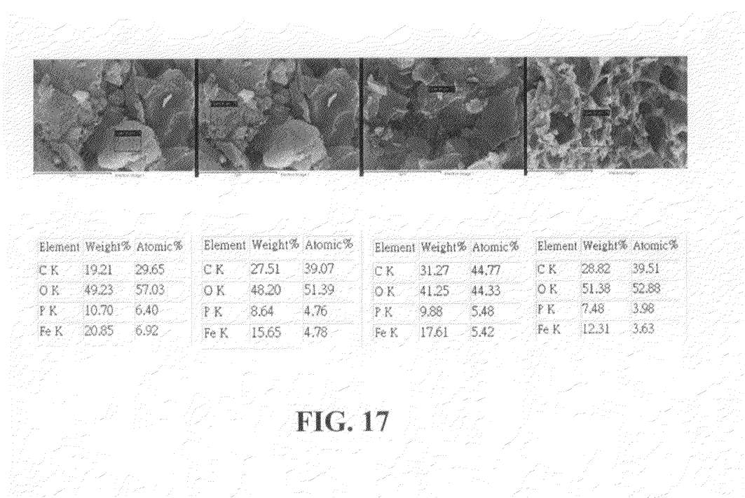

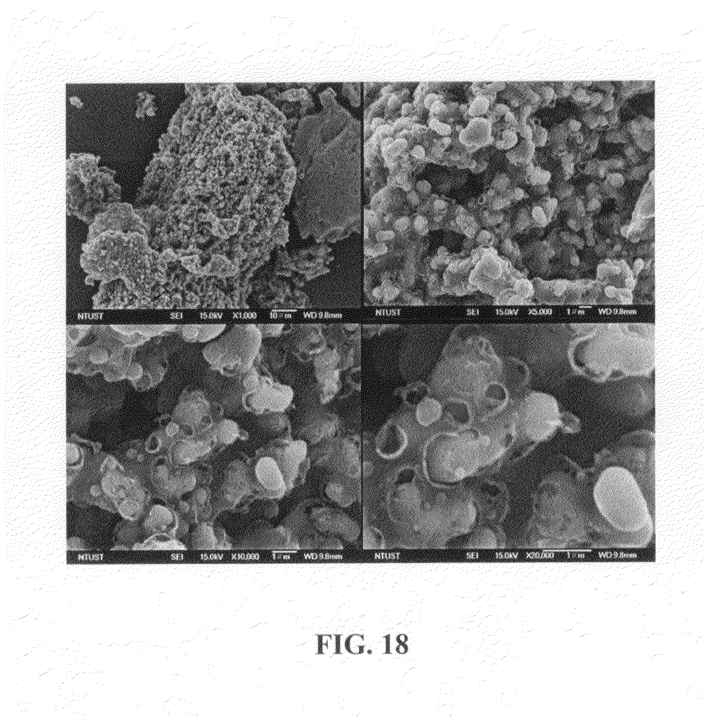

FIG. 16 shows the surface morphology of sample Li_{1.03}C_{1.5}N₈-ac-3H-800, almost no separated LiFePO₄ particles can be identified. This sample showed favorable mixture property. As shown in FIG. 17, the atomic ratio of Fe to P was consistent in sample Li_{1.03}C_{1.5}N₈-ac-3H-800. Similar Fe:P ratio was obtained at different regions of the sample, indicating that the LiFePO₄/bacterail cellulose carbon was mixed well. There were not too much impurities.

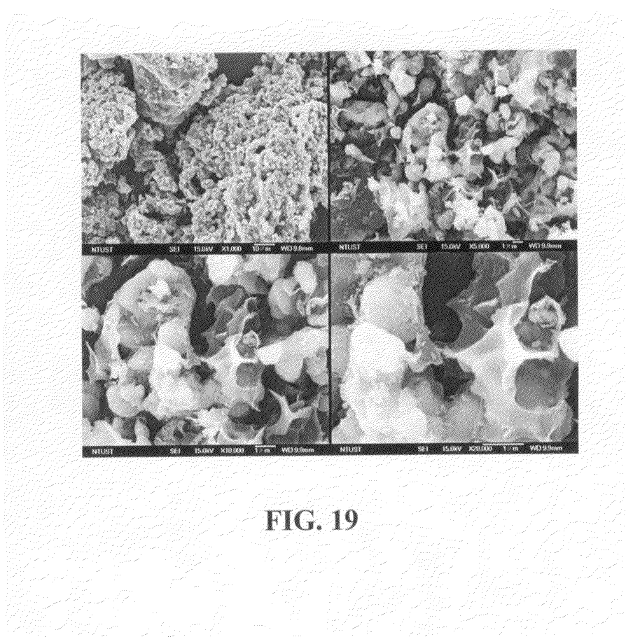

FIG. 18 shows the surface morphology of sample Li_{1.03}C_{1.5}N₈-ac-3H-900, which was calcined at 900° C. LiFePO₄ quickly grew to a size of about 1 μm due to the high calcination temperature. The bacterial cellulose carbon cover was destroyed and formed a bubble-like surface morphology. FIG. 19 shows the surface morphology of sample Li_{1.03}C_{1.5}N₈-ac-3H-1000, which was calcined at 1000° C. Bubble-like surface structures were also observed on this sample. It appears that calcination at high temperatures (e.g. 900° C. or 1,000° C.) led to interaction failure at the LiFePO₄/bacterial cellulose carbon interface. Therefore, the optimal calcination temperature LiFePO₄ and bacterial cellulose carbon mixture is 800° C.

### Example 7

### Graphitization Analysis of LiFePO₄/Bacterial Cellulose Carbon

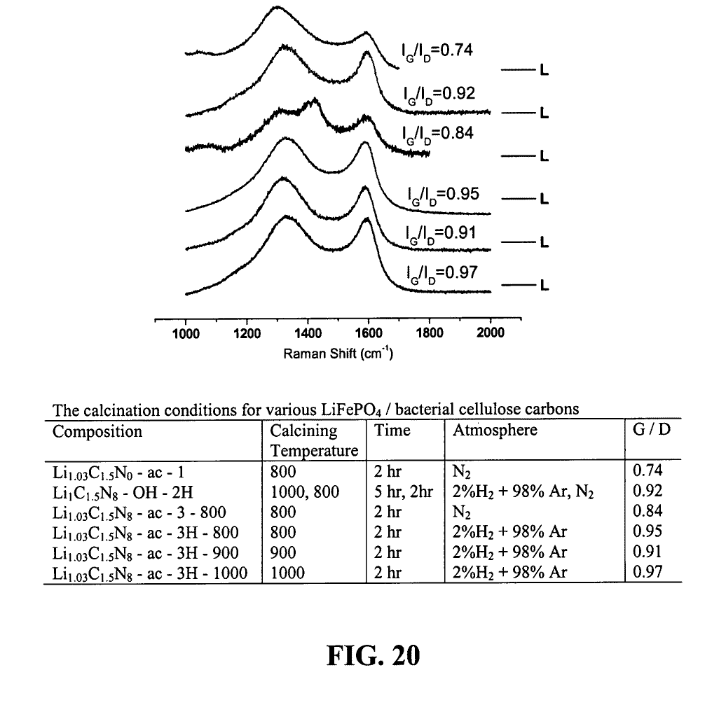

The G band/D band ratio (G/D ratio) of graphitized carbon in the LiFePO₄/bacterial cellulose carbon mixture was determined by Roman spectrum. As shown in FIG. 20 and Table 2, sample Li_{1.03}C_{1.5}N₀-ac-1-800 had the lowest G/D ratio of 0.74. This is because the sample did not contain bacterial cellulose carbon. The only carbon source was the carbon formed by calcining citric acid. Since it is difficult to graphitize citric acid, the level of graphitization was low. The G/D ratio was 0.84 in sample Li_{1.03}C_{1.5}N₈-ac-3-800, which was calcined under N₂ gas. Compared to sample Li_{1.03}C_{1.5}N₀-ac-1-800, sample Li_{1.03}C_{1.5}N₈-ac-3-800 had higher level of graphitization due to the presence of bacterial cellulose carbon. The G/D ratios were even higher in sample Li₁C_{1.5}N₈—OH-2H-800 (0.92) and sample Li_{1.03}C_{1.5}N₈-ac-3H-800 (0.95), both of which were calcined under reducing conditions (2% H₂ atmosphere). It thus appears that reducing condition is beneficial to the graphitization of bacterial cellulose in a LiFePO₄/bacterial cellulose mixture. In addition, the G/D ratio of sample Li₁C_{1.5}N₈—OH-2H-800 (prepared by a double calcination method. i.e., using calcined bacterial cellulose carbon as carbon source to absorb LiFePO₄ sol-gel, then calcining at 800° C.) was similar to that of sample Li_{1.03}C_{1.5}N₈-ac-3H-800 (prepared by a single calcination method, i.e., using uncalcined bacterial cellulose film as carbon source to absorb LiFePO₄ sol-gel, then calcining at 800° C.). Therefore, it appears that a switch between these two carbon sources would not affect the G/D ratio. There was no significant increase in the level of graphitization (i.e., an increase in the G/D ratio) in samples prepared by the single calcination method at 900° C., 1000° C. or higher temperatures, such as samples Li_{1.03}C_{1.5}N₈-ac-3H-900 (G/D ratio=0.91) and Li_{1.03}C_{1.5}N₈-ac-3H-1000 (G/D ratio=0.97). It is possible that the rapid growth of LiFePO₄ particles at these temperatures destroyed the sheet structure of bacterial cellulose carbon and hence prevented further graphitization.

### Example 8

### Electrochemical Property Test of LiFePO₄/NATA Carbon

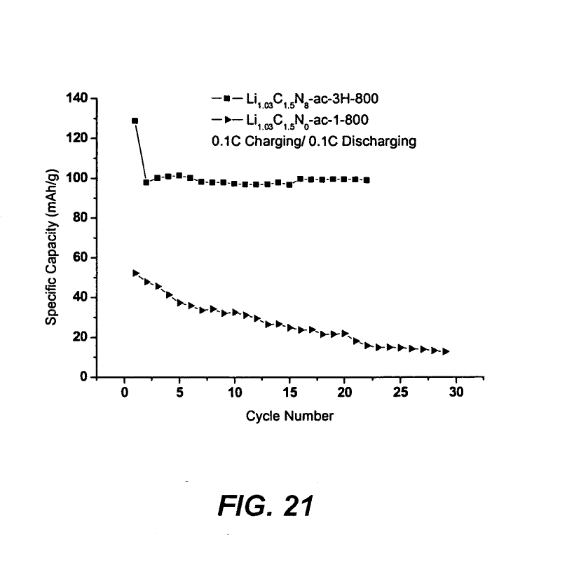

X-ray diffraction (XRD) analysis of the crystal structure of LiFePO₄/bacterial cellulose carbon suggests that samples with lithium acetate as the lithium source possess more favorable electrochemical properties. Accordingly, sample Li_{1.03}C_{1.5}N₈-ac-3H-800 was selected for a charging/discharging test. Sample Li_{1.03}C_{1.5}N₀-ac-1-800 was used as a control in the same test. As shown in FIG. 21, at a charging/discharging rate of 0.1 C, sample Li_{1.03}C_{1.5}N₈-ac-3H-800 has an electric capacity of about 100 mAh/g, which is much lower than LiFePO₄'s theoretical electric capacity of 170 mAh/g. However, the discharging cycling was very stable and the electric capacity remained almost the same after 23 cycles. In contrast, the control sample Li_{1.03}C_{1.5}N₀-ac-1-800 showed much lower electric capacity and poor stability. During test, the electric capacity quickly dropped from 60 mAh/g to 15 mAh/g after 30 cycles. This result is consistent with the surface morphology and levels of graphitization in these samples.

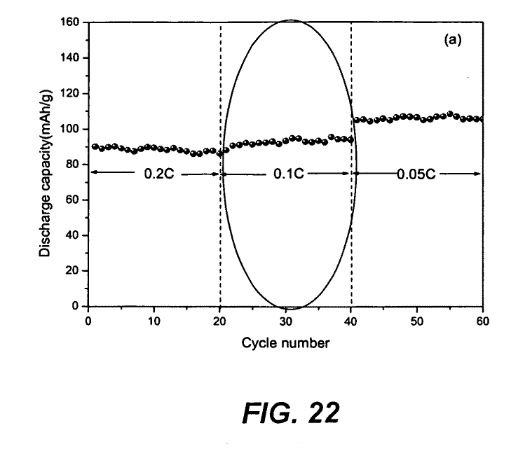

FIG. 22 shows the cyclability of a cathode material made from LiFePO₄ and 10 wt % commercial high conductivity carbon. As shown in FIG. 20, well mixed LiFePO₄/commercial carbon only reached a discharging electric capacity of about 90-95 mAh/g at a charging/discharging rate of 0.1 C. In contrast, a cathode material made from LiFePO₄ and 8 wt % bacterial cel ulose provided a discharging electric capacity of about 100 mAh/g, suggesting that bacterial cellulose carbon has favorable electrochemical properties.

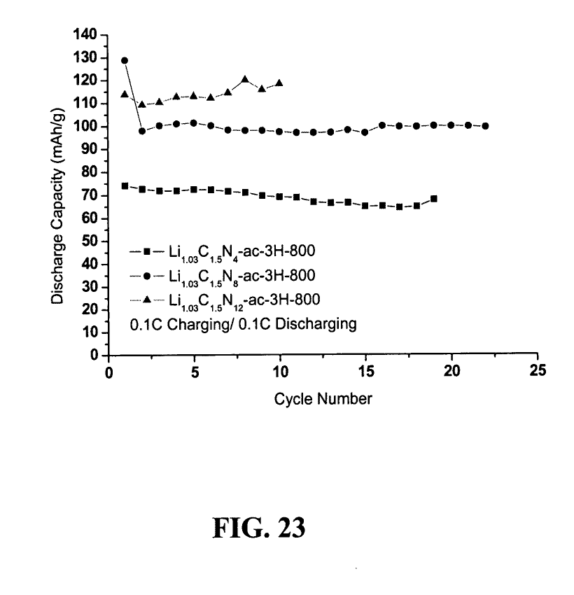

As shown in FIG. 23, if the content of bacterial cellulose carbon in the cathode material was reduced from 8 wt % to 4 wt %, the discharging electric capacity dropped from 100 mAh/g to about 70 mAh/g. In contrast, When the content of bacterial cellulose carbon increased from 8 wt % to 12 wt %, the discharging electric capacity was increased from about 100 mAh/g to about 115 mAh/g, indicating that the increase of carbon content could enhance the performance of the cathode material.

### Example 9

### Electrochemical Property of Bacterial Cellulose Film as a Separator

In order to avoid the direct interact of cathode and anode, a separator is usually placed between the cathode and the anode in a lithium iron cell (see, e.g., FIG. 7). In the present study, the hydroxyl group in the bacterial cellulose film was eliminated by treatment with formaldehyde or glutaraldehyde. The resulting porous bacterial cellulose film was used as a bacterial cellulose separator and its performance was tested.

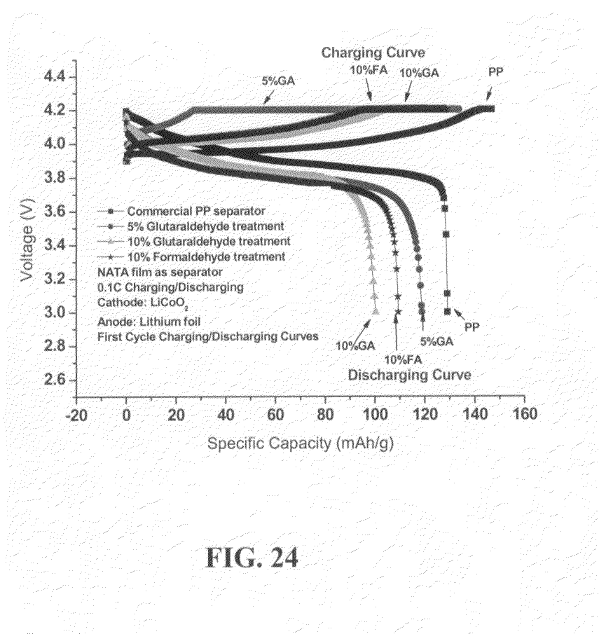

Briefly, coin battery cells were assembled with commercial LiCoO₂ as the anode material, lithium metal as the cathode material, and polypropylene or bacterial cellulose membranes prepared under different treatment conditions as separators. FIG. 24 shows the first cycle charging and discharging curves at 0.1 C from these coin cells.

Compared to cells with a polypropylene membrane, cells with aldehyde-treated bacterial cellulose separators showed a longer 4.2V plateau. This is probably resulted from the formation of thick passivation layers on the cathode lithium due to the incomplete elimination of hydroxyl groups in the bacterial cellulose. The thick passivation layers result in higher impedance inside the battery cells and hence longer plateaus in the corresponding discharging curves. Moreover, the reaction voltage for the oxidation of Co³⁺ to Co⁴⁺ is 4.1 V in the cell with a 5% glutaraldehyde-treated bacterial cellulose separator (4.03 V in cells with 10% glutaraldehyde- or 10% formaldehyde-treated bacterial cellulose separator). This voltage is much higher than the same reaction voltage in cells with a polypropylene separator. The reaction voltage for the reduction of Co⁴⁺ to Co³⁺, on the other hand, is lower than the same voltage in cell with a polypropylene membrane (3.9V). These results also suggest that the excess OH groups in the bacterial cellulose separator resulted in an increase of internal impedance

As shown in Table 2, the irreversible first cycle electric capacity of cells with polypropylene separator (17.74 mAh/g) was not significantly different from that of cells with aldehyde-treated bacterial cellulose (14 to 20 mAh/g). It thus appears that the remaining —OH group in the bacterial cellulose reacted with the electrode at the time when the bacterial cellulose separators were assembled into battery cells, which showed a negative effect on the charging/discharging curve but had little impact on the irreversible electric capacity.

TABLE 2
Irreversible 1^{st} cycle capacity of coin battery cells with
various separators

| | 1^{st} cycle Irreversible |
|---|---|
| Separator | Capacity (mAh/g) |
| PP | 17.74 |
| 5% GA - treated | 14.81 |
| 10% GA - treated | 20.62 |
| 10% FA - treated | 19.21 |

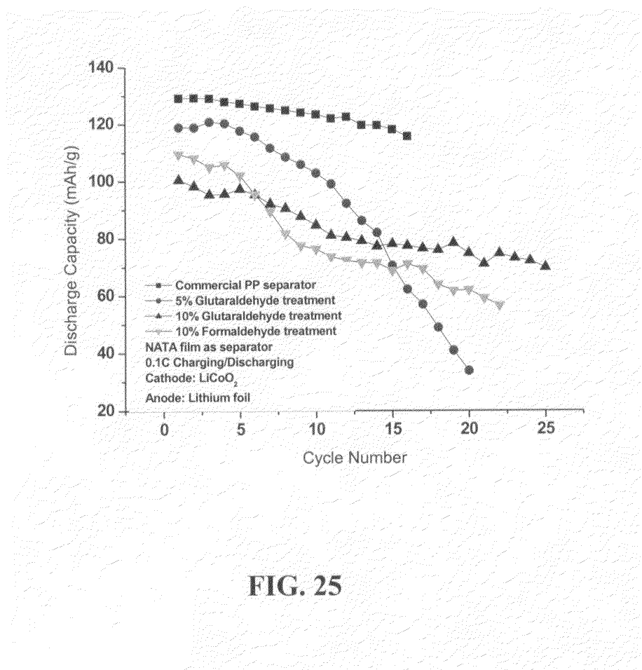

As shown in FIG. 25, the initial electric capacity reached 100 mAh/g in cells having bacterial cellulose separator treated with 10% glutaraldehyde, 110 mAh/g in cells having bacterial cellulose separator treated with 5% formaldehyde, and 120 mAh/g in cells having bacterial cellulose separator treated with 5% glutaraldehyde.

When used in combination with the commercial LiCoO₂ cathode material, the initial electric capacities of coin cells having aldehyde-treated bacterial cellulose separator were not comparable to the initial electric capacities (130 mAh/g) of polypropylene separator which is used in commercial lithium battery cells. Moreover, the electric capacity of coin cells with aldehyde-treated bacterial cellulose separators declined significantly after 5-6 charging/discharging cycles. The electric capacity is further reduced to 80 mAh/g after 20 charging/discharging cycles.

As shown in Table 3, the fading rate of cells with bacterial cellulose separator treated with 10% glutaraldehyde is 1.08 mAh/g, which was not significantly different from the fading rate of cells with polypropylene separator (0.8 mAh/cycle). Further optimization of the aldehyde-treatment conditions may be needed for bacterial cellulose films to achieve electrochemical properties comparable to those of commercial polypropylene membranes.

TABLE 3
Fading rates of coin battery cells having different separators

| | Fading rate |
|---|---|
| Separator | (mAh/cycle) |
| PP | 0.80 |
| 5% GA - treated | 4.50 |
| 10% GA - treated | 1.08 |
| 10% FA - treated | 2.21 |

What is claimed is:

1. A carbon nanotubes-like material, comprising bacterial cellulose carbonized under an anaerobic atmosphere.

2. The carbon nanotubes-like material of claim 1, wherein said anaerobic atmosphere is 100% N₂.

3. The carbon nanotubes-like material of claim 1, wherein said anaerobic atmosphere is 2% (v/v) H₂ and 98% (v/v) Ar.

4. The carbon nanotubes-like material of claim 1, wherein said bacterial cellulose is carbonized at a temperature in the range of 600-1200° C.

5. The carbon nanotubes-like material of claim 4, wherein said bacterial cellulose is carbonized at a temperature in the range of 800-1000° C.

6. A carbon nanotubes-like material of claim 1, wherein said bacterial cellulose is produced by a bacterium selected from the group consisting of Acetobacter, Rhizobium, Agrobacterium, and Sarcina.

7. A carbon nanotubes-like material of claim 6, wherein said bacterium is Acetobacter xylinum.

8. A method for producing a carbon nanotubes-like material, comprising:
calcining a bacterial cellulose under an anaerobic atmosphere at a temperature range of 600-1200° C.

9. The method of claim 8, further comprising the step of:
dehydrating said bacterial cellulose before the calcining step.

10. The method of claim 8, wherein said anaerobic atmosphere is 100% N₂.

11. The method of claim 8, wherein said anaerobic atmosphere is 2% (v/v) H₂ and 98% (v/v) Ar.

12. The method of claim 8, wherein said bacterial cellulose is produced by a bacterium selected from the group consisting of Acetobacter, Rhizobium, Agrobacterium, and Sarcina.

13. The method of claim 12, wherein said bacterium is Acetobacter xylinum.

14. A cathode material for lithium batteries, comprising carbonized bacterial cellulose and LiFePO_{4.}

15. The cathode material of claim 14, wherein said bacterial cellulose is produced by a bacterium selected from the group consisting of Acetobacter, Rhizobium, Agrobacterium, and Sarcina.

16. The cathode material of claim 15, wherein said bacterium is Acetobacter xylinum.

17. An anode material for batteries, comprising bacterial cellulose calcined in a reducing atmosphere containing 2% (v/v) H₂ and 98% (v/v) Ar at 1000° C.

18. The anode material of claim 17, wherein said bacterial cellulose is produced by a bacterium selected from the group consisting of Acetobacter, Rhizobium, Agrobacterium, and Sarcina.

19. The anode material of claim 18, wherein said bacterium is Acetobacter xylinum.

20. A separator membrane for a battery, comprising bacterial cellulose.

21. The separator membrane of claim 20, wherein said bacterial cellulose is produced by Acetobacter xylinum.

22. The separator membrane of claim 20, wherein said bacterial cellulose is aldehyde-treated bacterial cellulose.

23. The separator membrane of claim 22, wherein said aldehyde-treated bacterial cellulose is treated with 10% glutaraldehyde at 60° C. for 24 hours.

24. A lithium battery comprising a component comprising bacterial cellulose.

25. The lithium battery of claim 24, wherein said component is a cathode.

26. The lithium battery of claim 25, wherein said cathode comprises a mixture of LiFePO₄ and bacterial cellulose.

27. The lithium battery of claim 26, wherein said mixture is calcined under a reducing environment.

28. The lithium battery of claim 27, wherein said reducing environment comprises 2% (v/v) H₂ and 98% (v/v) Ar.

29. The lithium battery of claim 26, wherein said mixture is calcined at 800° C. for 2 hours.

30. The lithium battery of claim 26, wherein said LiFePO₄ is formed by titrating a Li/Fe solution with citric acid and mixing the titrated Li/Fe solution with NH₄H₂PO₄.

31. The lithium battery of claim 30, wherein said Li/Fe solution is prepared by mixing a LiCH₂COOH solution with a Fe(NO₃)₃ solution.

32. The lithium battery of claim 26, wherein said LiFePO₄ is prepared with a Li:Fe:citric acid:PO4: molar ratio of 1.03:1:1.5:1.

33. The lithium battery of claim 26, wherein said bacterial cellulose is added to the LiFePO₄ solution to a final concentration of 8% (wt/wt).

34. The lithium battery of claim 24, wherein said component is an anode.

35. The lithium battery of claim 34, wherein said anode comprises bacterial cellulose calcined in a reducing atmosphere containing 2% H₂ and 98% Ar.

36. The lithium battery of claim 35, wherein said bacterial cellulose is calcined at 1000° C.

37. The lithium battery of claim 24, wherein said component is a separator membrane.

38. The lithium battery of claim 37, wherein said separator membrane comprises aldehyde-treated bacterial cellulose film.

39. The lithium battery of claim 38, wherein said aldehyde is 10% glutaraldhyde.

40. The lithium battery of claim 38, wherein said bacterial cellulose is produced by Acetobacter xylinum.

41. A method for preparing a cathode material, comprising:
preparing a Li/Fe solution comprising Li⁺ and Fe³⁺;
titrating said Li/Fe solution with citric acid;
adding PO₄⁻ to titrated Li/Fe solution to form LiFePO₄;
adding bacterial cellulose to LiFePO₄ to form a LiFePO₄/bacterial cellulose mixture; and
calcining said LiFePO₄/bacterial cellulose mixture to form said cathode material.

42. The method of claim 41, wherein said Li/Fe solution comprises CH₃COOHLi and Fe(NO₃)₃.

43. The method of claim 41, wherein aid Li/Fe solution has a Li:Fe molar ratio of 1.03:1.

44. The method of claim 41, wherein said Li/Fe solution is titrated with citric acid to a Li:Fe:citric acid molar ratio of 1.03:1:1.5.

45. The method of claim 41, wherein said PO₄⁻ is added in the form of NH₄H₂PO₄.

46. The method of claim 45, wherein said NH₄H₂PO₄ is added to reach a Li:Fe:citric acid:PO₄ molar ratio of 1.03:1:1.5:1.

47. The method of claim 46, wherein said bacterial cellulose is added to reach a final concentration of 8% (wt/wt).

48. The method of claim 41, wherein said LiFePO₄/bacterial cellulose mixture is calcined in a reducing atmosphere containing 2% (v/v) H₂ and 98% (v/v).

49. The method of claim 48, wherein said LiFePO₄/bacterial cellulose mixture is calcined at 800° C.

50. The cathode material produced by the method of claim 41.

51. A method for preparing a separator for a battery, comprising:
treating a bacterial cellulose film with an aldehyde; and
baking treated bacterial cellulose film to remove residue aldehyde.

52. The method of claim 51, wherein said bacterial cellulose is produced by Acetobacter xylinum.

53. The method of claim 51, wherein said bacterial cellulose film is treated with 10% glutaraldehyde at 60° C. for 24 hours.

54. A method for removing hydroxyl groups in a bacterial cellulose film, comprising:
soaking said bacterial cellulose film in 10% glutaraldehyde at 60° C. for 24 hours; and
baking said bacterial cellulose film to remove residue glutaraldehyde.
